(19) United States
(12) Patent Application Publication
(10) Pub. No.: US 2021/0163014 A1
(43) Pub. Date: Jun. 3, 2021

(54) ROAD SURFACE DAMAGE DETECTION DEVICE, ROAD SURFACE DAMAGE DETECTION METHOD, AND PROGRAM

(71) Applicant: TOYOTA JIDOSHA KABUSHIKI KAISHA, Toyota-shi, (JP)

(72) Inventors: Yosuke KIMURA, Nissin-shi (JP); Takeo MORIAI, Nagakute-shi (JP); Masaya FUJIMORI, Susono-shi (JP); Tatsuya OBUCHI, Obu-shi (JP)

(73) Assignee: TOYOTA JIDOSHA KABUSHIKI KAISHA, Toyota-shi (JP)

(21) Appl. No.: 16/939,381

(22) Filed: Jul. 27, 2020

(30) Foreign Application Priority Data
Nov. 29, 2019 (JP) 2019-216124

(51) Int. Cl. B60W 40/06; B60W 50/14

(52) U.S. Cl. CPC B60W 40/06; B60W 50/14; B60W 2556/65; B60W 2552/35; B60W 2400/00; B60W 2050/146

(57) ABSTRACT

A road surface damage detection device is configured to calculate, for each of road sections, a maximum variation rate that is a maximum value of a variation amount of a wheel speed per unit time in each of vehicles. Next, the device is configured to periodically select, for each of the road sections, a maximum value from the maximum variation rate of each of the vehicles in a first prescribed period, set the selected maximum value as a section maximum variation rate, and determine whether or not the road surface damage has occurred by comparing the section maximum variation rate with a threshold. The device sets the threshold, for each of the road sections, based on a behavior of each of the vehicles in a second prescribed period or based on the behavior of each of the vehicles when a predetermined condition is satisfied.

### CROSS-REFERENCE TO RELATED APPLICATION

This application claims priority to Japanese Patent Application No. 2019-216124 filed on Nov. 29, 2019, incorporated herein by reference in its entirety.

### BACKGROUND

### 1. Technical Field

The present disclosure relates to a road surface damage detection device, a road surface damage detection method, and a program.

### 2. Description of Related Art

As a road surface damage detection device of this type, there has been proposed a device configured to select information used for analysis, out of a plurality of pieces of information for analysis (such as road surface images, rutting, and acceleration) from vehicles for each of road sections, analyze the selected information for analysis, calculate a representative value (for example, a maximum value) of analysis result information, and generate a warning signal when the calculated representative value exceeds a threshold (see, for example, Japanese Patent Application Publication No. 2005-249525).

### SUMMARY

In the aforementioned road surface damage detection device, a fixed value is used as a threshold. Accordingly, when a road surface damage, such as a pothole, occurs in each of the road sections, there is a possibility that appropriate detection of the road surface damage may fail.

A primary object of a road surface damage detection device, a road surface damage detection method, and a program of the present disclosure is to appropriately detect a road surface damage when the road surface damage occurs in each of the road sections.

To accomplish the primary object, the road surface damage detection device, the road surface damage detection method, and the program of the present disclosure take following measures.

A road surface damage detection device of the present disclosure is a road surface damage detection device for detecting a road surface damage for each of road sections based on vehicle information from each of vehicles that have traveled. The device includes a first processor and a second processor. The first processor is configured to calculate, for each of the road sections, a maximum variation rate that is a maximum value of a variation amount of a wheel speed per unit time in each of the vehicles. The second processor is configured to select, for each of the road sections, a maximum value from the maximum variation rate of each of the vehicles in a first prescribed period, set the selected maximum value as a section maximum variation rate, and determine whether or not the road surface damage has occurred by comparing the section maximum variation rate with a threshold. The second processor sets the threshold, for each of the road sections, based on a behavior of each of the vehicles in a second prescribed period or based on the behavior of each of the vehicles when a predetermined condition is satisfied.

The road surface damage detection device of the present disclosure is configured to calculate, for each of the road sections, a maximum variation rate that is a maximum value of a variation amount of a wheel speed per unit time in each of the vehicles. Next, the device is configured to periodically select, for each of the road sections, a maximum value from the maximum variation rate of each of the vehicles in a first prescribed period, set the selected maximum value as a section maximum variation rate, and determine whether or not the road surface damage has occurred by comparing the section maximum variation rate with a threshold. The device sets the threshold, for each of the road sections, based on a behavior of each of the vehicles in a second prescribed period or based on the behavior of each of the vehicles when a predetermined condition is satisfied. Accordingly, the threshold can be set appropriately as compared with the case where a fixed value is used as the threshold. As a result, when a road surface damage occurs for each of the road sections, the road surface damage can appropriately be detected.

Here, the “behavior of each of the vehicles” includes the maximum variation rate of each of the vehicles, and the average variation rate that is an average of the variation amount of the wheel speed per unit time in each of the vehicles. Examples of the “first prescribed period” may include a period corresponding to an execution interval of the second processor. Examples of the “second prescribed period” may include a period identical to the first prescribed period, a period after application (operation) of the road surface damage detection device is started, and a period after the road surface damage is repaired. Examples of the “predetermined condition” may include a condition for determining that the road surface damage has not occurred, and a condition for determining that the road surface damage has occurred.

In the road surface damage detection device of the present disclosure, the second processor may set as the threshold a value that is smaller by a margin than the section maximum variation rate when determining that the road surface damage has occurred in the past, for each of the road sections. In this case, the second processor may set the margin for each of the road sections, based on any one of the number of vehicles when determining that the road surface damage has occurred in the second prescribed period or in the past, the number of times of determination that the road surface damage has occurred in the past, and elapsed time from a prescribed time. In this way, the threshold can be set more appropriately. Examples of the “second prescribed period” in this case may include a period equal to the first prescribed period, and a period after application (operation) of the road surface damage detection device is started. Examples of the “prescribed time” may include the time when application (operation) of the road surface damage detection device is started.

In the road surface damage detection device of the present disclosure, the second processor may set as the threshold a value that is larger by a margin than the section maximum variation rate when determining that the road surface damage has not occurred in the past, for each of the road sections. In this case, the second processor may set the margin for each of the road sections, based on any one of the number of vehicles when determining that the road surface damage has not occurred in the second prescribed period or in the past, the number of times of determination that the road surface damage has not occurred in the past, and elapsed time from a prescribed time. In this way, the threshold can be set more appropriately. Examples of the “second prescribed period” in this case may include a period equal to the first prescribed period, a period after application (operation) of the road surface damage detection device is started, and a period after the road surface is repaired. Examples of the “prescribed time” may include the time when application (operation) of the road surface damage detection device is started, and the time when the road surface failure is repaired.

In the aspect of the road surface damage detection device of the present disclosure in which the threshold is set based on the section maximum variation rate when it is determined that the road surface damage has occurred or has not occurred in the past for each of the road sections, the first processor may calculate, for each of the road sections, an average variation rate that is an average of the variation amount of the wheel speed per unit time in each of the vehicles, and when the number of vehicles for each of the road sections in the first prescribed period is less than a predetermined number, the second processor may set as the section average variation rate an average of the average variation rate of each of the vehicles when determining that the road surface damage has not occurred in the second prescribed period or in the past, and set the threshold based on the section average variation rate. In this case, the second processor may calculate an interquartile range using the maximum variation rate of each of the vehicles when determining that the road surface damage has not occurred in the second prescribed period or in the past, and set as the threshold a sum of the section average variation rate and a value obtained by multiplying the interquartile range by a coefficient. In this case, the second processor may set the coefficient based on the number of vehicles when determining that the road surface damage has not occurred in the second prescribed period or in the past. When the number of vehicles in the first prescribed period is less than the predetermined number, statistical certainty of the section maximum variation rate used for comparison with the threshold is relatively low. Accordingly, when the threshold is set based on the section maximum variation rate when it is determined that the road surface damage has occurred or has not occurred in the past, it is desirable to use a relatively large margin. Hence, it may be considered to set the threshold in this manner. Examples of the “second prescribed period” in this case may include a period equal to the first prescribed period, a period after application (operation) of the road surface damage detection device is started, and a period after the road surface is repaired.

In the aspect of the road surface damage detection device of the present disclosure in which the threshold is set based on the section maximum variation rate when it is determined that the road surface damage has occurred or has not occurred in the past for each of the road sections, when the number of vehicles for each of the road sections in the first prescribed period is less than a predetermined number, the second processor may calculate a second quartile or a third quartile using the maximum variation rate of each of the vehicles when determining that the road surface damage has not occurred in the second prescribed period or in the past, and set the threshold based on the second quartile or the third quartile. In this case, the second processor may calculate an interquartile range using the maximum variation rate of each of the vehicles when determining that the road surface damage has not occurred in the second prescribed period or in the past, and set as the threshold a sum of the second quartile or the third quartile and a value obtained by multiplying the interquartile range by a coefficient. In this case, the second processor may set the coefficient based on the number of vehicles when determining that the road surface damage has not occurred in the second prescribed period or in the past. When the number of vehicles in the first prescribed period is less than the predetermined number, statistical certainty of the section maximum variation rate used for comparison with the threshold is relatively low. Accordingly, when the threshold is set based on the section maximum variation rate when it is determined that the road surface damage has occurred or has not occurred in the past, it is desirable to use a relatively large margin. Hence, it may be considered to set the threshold in this manner. Examples of the “second prescribed period” in this case may include a period equal to the first prescribed period, a period after application (operation) of the road surface damage detection device is started, and a period after the road surface is repaired.

In the road surface damage detection device of the present disclosure, the first processor may be configured to calculate, for each of the road sections, an average variation rate that is an average of the variation amount of the wheel speed per unit time in each of the vehicles. The second processor may set as the section average variation rate an average of the average variation rate of each of the vehicles when determining that the road surface damage has not occurred in the second prescribed period or in the past, and set the threshold based on the section average variation rate, for each of the road sections. In this case, the second processor may calculate an interquartile range using the maximum variation rate of each of the vehicles when determining that the road surface damage has not occurred in the second prescribed period or in the past, and set as the threshold a sum of the section average variation rate and a value obtained by multiplying the interquartile range by a coefficient. In this case, the second processor may set the coefficient based on the number of vehicles when determining that the road surface damage has not occurred in the second prescribed period or in the past. In this way, the threshold can be set more appropriately. Examples of the “second prescribed period” in this case may include a period equal to the first prescribed period, a period after application (operation) of the road surface damage detection device is started, and a period after the road surface is repaired.

In the road surface damage detection device of the present disclosure, the second processor may calculate, for each of the road sections, a second quartile and a third quartile using the maximum variation rate of each of the vehicles when determining that the road surface damage has not occurred in the second prescribed period or in the past, and set the threshold based on the second quartile or the third quartile. In this case, the second processor may calculate an interquartile range using the maximum variation rate of each of the vehicles when determining that the road surface damage has not occurred in the second prescribed period or in the past, and set as the threshold a sum of the second quartile or the third quartile and a value obtained by multiplying the interquartile range by a coefficient. In this case, the second processor may set the coefficient based on the number of vehicles when determining that the road surface damage has not occurred in the second prescribed period or in the past. In this way, the threshold can be set more appropriately. Examples of the “second prescribed period” in this case may include a period equal to the first prescribed period, a period after application (operation) of the road surface damage detection device is started, and a period after the road surface is repaired.

A road surface damage detection method of the present disclosure is a road surface damage detection method for detecting a road surface damage for each of road sections based on vehicle information from each of vehicles that have traveled. The method includes: (a) a step of calculating, for each of the road sections, a maximum variation rate that is a maximum value of a variation amount of a wheel speed per unit time in each of the vehicles; and (b) a step of selecting, for each of the road sections, a maximum value from the maximum variation rate of each of the vehicles in a first prescribed period, setting the selected maximum value as a section maximum variation rate, and determining whether or not the road surface damage has occurred by comparing the section maximum variation rate with a threshold. In the step (b), the threshold is set, for each of the road sections, based on a behavior of each of the vehicles in a second prescribed period or based on the behavior of each of the vehicles when a predetermined condition is satisfied.

In the road surface damage detection method of the present disclosure, for each road section, a maximum variation rate that is a maximum value of a variation amount of a wheel speed per unit time in each vehicle is calculated. Next, for each of the road sections, a maximum value is periodically selected from the maximum variation rate of each of the vehicles in a first prescribed period, the selected maximum value is set as a section maximum variation rate, and whether or not the road surface damage has occurred is determined by comparing the section maximum variation rate with a threshold. Then, the threshold is set, for each of the road sections, based on a behavior of each of the vehicles in a second prescribed period or based on the behavior of each of the vehicles when a predetermined condition is satisfied. Accordingly, the threshold can be set appropriately as compared with the case where a fixed value is used as the threshold. As a result, when a road surface damage occurs for each of the road sections, the road surface damage can appropriately be detected.

A program of the present disclosure is a program for causing a computer to function as a road surface damage detection device for detecting a road surface damage for each of road sections based on vehicle information from each of vehicles that have traveled. The program includes: (a) a step of calculating, for each of the road sections, a maximum variation rate that is a maximum value of a variation amount of a wheel speed per unit time in each of the vehicles; and (b) a step of selecting, for each of the road sections, a maximum value from the maximum variation rate of each of the vehicles in a first prescribed period, setting the selected maximum value as a section maximum variation rate, and determining whether or not the road surface damage has occurred by comparing the section maximum variation rate with a threshold. In the step (b), the threshold is set, for each of the road sections, based on a behavior of each of the vehicles in a second prescribed period or based on the behavior of each of the vehicles when a predetermined condition is satisfied.

In the program of the present disclosure, for each road section, a maximum variation rate that is a maximum value of a variation amount of a wheel speed per unit time in each vehicle is calculated. Next, for each of the road sections, a maximum value is periodically selected from the maximum variation rate of each of the vehicles in a first prescribed period, the selected maximum value is set as a section maximum variation rate, and whether or not the road surface damage has occurred is determined by comparing the section maximum variation rate with a threshold. Then, the threshold is set, for each of the road sections, based on a behavior of each of the vehicles in a second prescribed period or based on the behavior of each of the vehicles when a predetermined condition is satisfied. Accordingly, the threshold can be set appropriately as compared with the case where a fixed value is used as the threshold. As a result, when a road surface damage occurs for each of the road sections, the road surface damage can appropriately be detected.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a block diagram showing an outlined configuration of a road management system 10 including a road surface damage detection device as an embodiment of the present disclosure;

FIG. 2 is a flowchart showing an example of a road surface damage determination routine executed by the road surface damage determiner 23;

FIG. 3 is an explanatory view showing an example of a margin setting map;

FIG. 4 is an explanatory view showing examples of a section maximum variation rate ΔVms and a damage flag Fd at each date;

FIG. 5 is a flowchart showing an example of the road surface damage determination routine in a modification;

FIG. 6 is an explanatory view showing an example of a margin setting map;

FIG. 7 is a flowchart showing an example of the road surface damage determination routine in a modification;

FIG. 8 is an explanatory view showing an example of the relationship between a vehicle maximum variation rate ΔVmv[i] and relative frequency;

FIG. 9 is an explanatory view showing an example of a coefficient setting map;

FIG. 10 is a flowchart showing an example of the road surface damage determination routine in a modification;

FIG. 11 is a flowchart showing an example of the road surface damage determination routine in a modification;

FIG. 12 is an explanatory view showing an example of the coefficient setting map; and

FIG. 13 is an explanatory view showing an example of a display screen of a display 43.

### DETAILED DESCRIPTION OF EMBODIMENTS

Now, aspects for carrying out the present disclosure will be described based on embodiments.

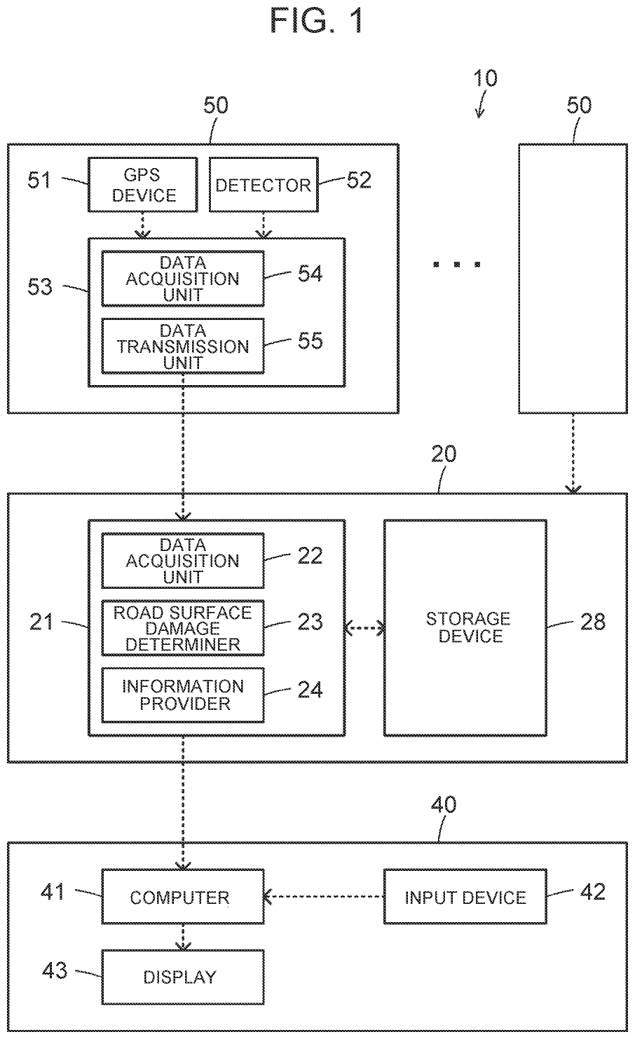

FIG. 1 is a block diagram showing an outlined configuration of a road management system 10 including a road surface damage detection device as an embodiment of the present disclosure. As shown in the drawing, the road management system 10 of the embodiment includes a server 20 as a road surface damage detection device that can wirelessly communicate with each of vehicles 50, and a terminal device 40 that can communicate with the server 20 in a wired or wireless manner. In the following description, the road includes public roads (driveways and sidewalks) as well as private roads and parking lots (for example, passages). The “road surface damage detection device” of the embodiment corresponds to the server 20.

Each of the vehicles 50 includes a GPS device 51 that acquires location information relating to the current location of the vehicle, a detector 52 that detects behavior information relating to the behavior of the vehicle 50, and an electronic control unit (hereinafter referred to as “ECU”) 53. The detector 52 includes a sensor for detecting the information indicating the behavior of the vehicle 50, a sensor for detecting the information that influences the behavior of the vehicle 50, and a sensor for detecting the information regarding the periphery of the vehicle 50.

Here, examples of the information indicating the behavior of the vehicle 50 may include at least one of vehicle speed, wheel speed, longitudinal acceleration, lateral acceleration, a yaw rate, a yaw angle, a roll angle, a pitch angle, and a tire slip ratio.

Examples of the information that influences the behavior of the vehicle 50 may include an operating state of an operating device that a driver can operate, and an operational state of a support system for supporting the travel of the vehicle 50. Here, examples of the operating state of the operating device may include at least one of a steering angle or a steering speed of a steering wheel, a depression amount of an accelerator pedal, a depression amount of a brake pedal, a shift position of a shift lever, and the presence or absences of operation of blinkers. Examples of the support system may include at least one of a lane departure alert (LDA) system, an anti-lock brake system (ABS), a traction control (TRC) system, and an electronic stability control (ESC) system.

Examples of the sensor for detecting the information regarding the periphery of the vehicle 50 may include at least one of a camera, a radar, and a light detection and ranging (Lidar).

The ECU 53 includes a CPU, a ROM, a RAM, a flash memory, an input-output port, and a communication port. The ECU 53 includes a data acquisition unit 54 and a data transmission unit 55 as a functional block formed in collaboration with hardware and software. The data acquisition unit 54 acquires the location information regarding the vehicle 50 from the GPS device 51, and the behavior information regarding the vehicle 50 from the detector 52. The data transmission unit 55 wirelessly transmits the location information and the behavior information regarding the vehicle 50 acquired by the data acquisition unit 54 to the server 20 as the vehicle information.

The server 20 is configured as a computer that includes an arithmetic processing unit 21 and a storage device 28. The arithmetic processing unit 21 includes a CPU, a ROM, a RAM, a flash memory, an input-output port, and a communication port. The arithmetic processing unit 21 includes a data acquisition unit 22, a road surface damage determiner 23, and an information provider 24 as a functional block formed in collaboration with hardware and software. The data acquisition unit 22, the road surface damage determiner 23, and the information provider 24 exchange data with the storage device 28, respectively.

The data acquisition unit 22 wirelessly acquires vehicle information from the vehicles 50, and stores the information in the storage device 28. Based on the vehicle information from the vehicles 50, the road surface damage determiner 23 periodically determines whether a road surface damage has occurred for each of the road sections within a management target range, and stores determination results and the like in the storage device 28. Here, the “management target range” is defined as a range (for example, a prefecture range, a municipal range, etc.) desired by users (for example, persons in charge of government offices, etc.). The “road section” is defined as a section of about several meters to some ten meters), for example. Examples of the “road surface damage” may include potholes (small holes in comparison with street widths or vehicle widths). The road surface damage determiner 23 will be described later in detail.

The information provider 24 transmits various pieces of information to a computer 41 of the terminal device 40. The storage device 28 is configured as a hard disk, a solid state drive (SSD), or the like. The storage device 28 stores various pieces of information necessary for operation of the arithmetic processing unit 21. Examples of the information stored in the storage device 28 may include map information, vehicle information regarding the vehicles 50 acquired by the data acquisition unit 22, and information stored by the road surface damage determiner 23.

The terminal device 40 is configured as a desktop personal computer, a notebook computer, a tablet terminal, or the like. The terminal device 40 includes the computer 41, an input device 42 connected to the computer 41, and a display 43 as a display device. The computer 41 includes a CPU, a ROM, a RAM, a flash memory, a storage device (a hard disk, or a SSD), an input-output port, and a communication port. Examples of the input device 42 may include a mouse, a keyboard, and a touch panel.

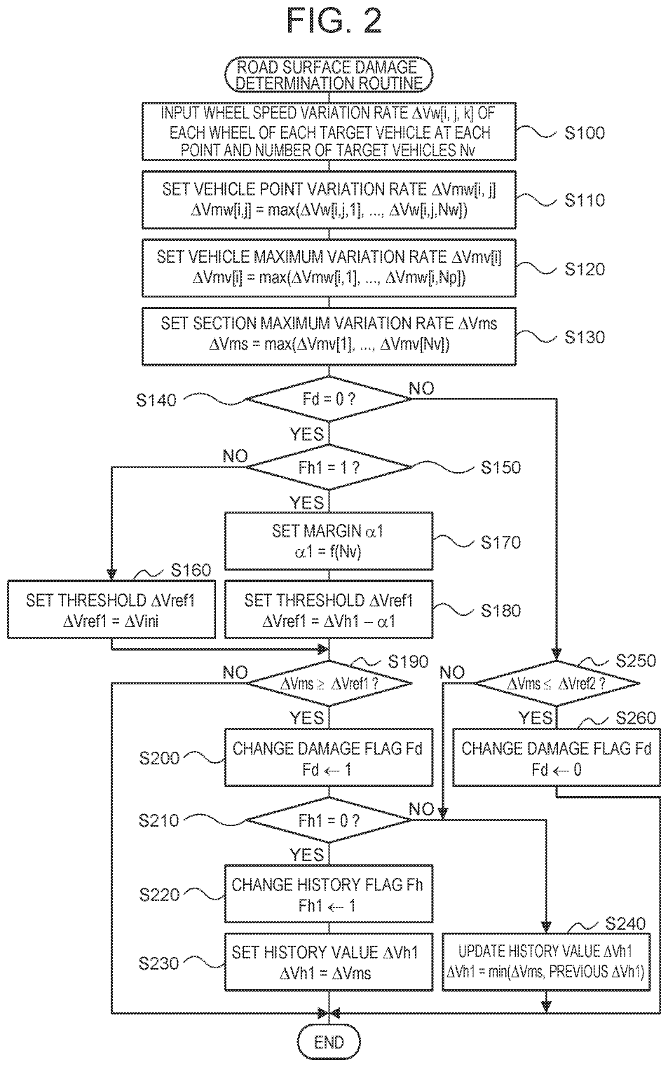

Next, description is given of the operation of the thus-configured server 20 of the embodiment, and particularly the operation of the road surface damage determiner 23. FIG. 2 is a flowchart showing an example of a road surface damage determination routine executed by the road surface damage determiner 23. The routine is executed periodically (for example, every other day, or every few days) with each of the road sections within the management target range being as a target section.

When the road surface damage determination routine of FIG. 2 is executed, the road surface damage determiner 23 first inputs a wheel speed variation rate (variation amount of wheel speed per unit time) of each wheel ΔVw[i, j, k] (i:1 to Nv, j:1 to Np, k:1 to Nw) in each of the vehicles 50 (hereinafter, referred to as “target vehicles”) that have traveled in a target section in a prescribed period, at every point (minute section) in the target section, and the number of the target vehicles (hereinafter, referred to as “number of targets”) Nv (step S100).

Here, the “prescribed period” is defined in accordance with an execution interval of the present routine. When the present routine is executed every other day, the “prescribed period” is defined as one day (24 hours) before the present routine is executed, for example. The “each wheel” corresponds to a left front wheel, a right front wheel, a left rear wheel, and a right rear wheel in the case of the vehicle 50 configured as an automatic four-wheel vehicle, and corresponds to a front wheel and a rear wheel in the case of the vehicle 50 configured as a motorcycle.

The variable i is a variable corresponding to each target vehicle, the variable j is a variable corresponding to each point, and the variable k is a variable corresponding to each wheel. The value Np is the number of points in a target section, and the value Nw is the number of wheels of each target vehicle.

When data is input in this way, as expressed by an expression (1), the road surface damage determiner 23 selects a maximum value out of the wheel speed variation rates ΔVw[i, j, 1] to ΔV[i, j, Nw] of each wheel at each point for each target vehicle, and sets the selected value as a vehicle point variation rate ΔVmw[i, j] at each point (step S110).

ΔVmw[i,j]=max(ΔVmw[i,j, 1], . . . , ΔVmw[i,j, Nw]) (1)

Next, as expressed by expression (2), the road surface damage determiner 23 selects a maximum value out of the vehicle point variation rates ΔVmw[i, 1] to ΔVmw[i, Np] at each point for each target vehicle, and sets the selected value as a vehicle maximum variation rate ΔVmv [i] in the target section (step S120).

ΔVmv[i]=max(ΔVmw[i, 1], . . . , ΔVmw[i, Np]) (2)

Then, as expressed by expression (3), the road surface damage determiner 23 selects a maximum value out of the vehicle maximum variation rates ΔVmv [1] to ΔVmv [Nv] in the target section for each target vehicle, and sets the selected value as a section maximum variation rate ΔVms in the target section for all the target vehicles (step S130).

ΔVms=max(ΔVmv[1], . . . , ΔVmv[Nv]) (3)

Next, the road surface damage determiner 23 checks the value of a damage flag Fd (step S140). Here, the damage flag Fd is a flag indicating whether or not a road surface damage has occurred in the target section. When operation of the server 20 for the target section is started, the damage flag Fd is set to a value zero as an initial value.

When the value of the damage flag Fd is zero in step S140, the road surface damage determiner 23 determines that the road surface damage has not occurred in the target section when the present routine was executed previous time, and checks the value of a history flag Fh1 (step S150). Here, the history flag Fh1 is a flag indicating whether or not there is a history of the present routine detecting any road surface damage in the target section (the damage flag Fd being changed from the value zero to the value one). As the history flag Fh1, a value zero is set as an initial value when operation of the server 20 is started for the target section.

When the history flag Fh1 has the value zero in step S150, the road surface damage determiner 23 determines that there is no history of the present routine detecting the road surface damage in the target section (determination is made for the first time), and sets an initial value ΔVini as a threshold ΔVref1 (step S160). Next, the road surface damage determiner 23 compares the section maximum variation rate ΔVms with the threshold ΔVref1 (step S190).

Here, the threshold ΔVref1 is a threshold used for determining whether or not the road surface damage has occurred in the target section. As the initial value ΔVini, values determined in advance based on analysis or an experiment are used. When a road surface damage occurs in the target section, the vehicle maximum variation rate ΔVmv[i] of the target vehicle that is influenced by the road surface damage is reflected upon the section maximum variation rate ΔVms. Accordingly, the section maximum variation rate ΔVms increases largely. The process of step S190 is performed in consideration of this increase.

When the section maximum variation rate ΔVms is less than the threshold ΔVref1 in step S190, the road surface damage determiner 23 determines that the road surface damage has not occurred in the target section, and ends the present routine while keeping the value of the damage flag Fd to zero. When the present routine is ended in this way, the road surface damage determiner 23 stores in the storage device 28 the date of executing the present routine, the road section set as the target section, the vehicle maximum variation rate ΔVmv[i], the section maximum variation rate ΔVms, and the damage flag Fd in association with each other.

When the section maximum variation rate ΔVms is equal to or greater than the threshold ΔVref1 in step S190, the road surface damage determiner 23 determines that the road surface damage has occurred, and changes the value of the damage flag Fd from zero to one (step S200). Thus, when a road surface damage, such as a pothole, occurs in the target section, the road surface damage can be detected.

Thus, when the road surface damage determiner 23 determines that the road surface damage has occurred at least in one section out of the respective road sections included in the management target range, the information provider 24 prepares a list, or the like, of the road sections where the road surface damage has occurred, and transmits the list or the like to the terminal device 40. Accordingly, a user (for example, a person in charge of a government office, etc.) who operates the terminal device 40 can check the road sections where the road surface damage has occurred. As a result, a construction dealer, or the like, commissioned by the user can repair the road surface damage.

Next, the road surface damage determiner 23 checks the value of history flag Fh1 (step S210). When the history flag Fh1 has the value zero, the road surface damage determiner 23 determines that there is no history of the present routine detecting the road surface damage in the target section (detection is made for the first time), and changes the history flag Fh1 to the value one (step S220). Then, the road surface damage determiner 23 sets the section maximum variation rate ΔVms to the history value ΔVh1 (step S230), and ends the present routine. When the history value ΔVh1 is set in this way, the road surface damage determiner 23 stores, in the storage device 28, the road section set as the target section and the history value ΔVh1 in association with each other.

When the history flag Fh1 has the value one in step S210, the road surface damage determiner 23 determines that there is a history of the present routine detecting the road surface damage in the target section, and keeps the history flag Fh1 to the value one. Then, as expressed by an expression (4), the road surface damage determiner 23 sets the smaller one of the section maximum variation rate ΔVms and the previous history value (previous ΔVh1) as a new history value ΔVh1 (step S240), and ends the present routine.

ΔVh1=min (ΔVms, previous ΔVh1) (4)

When the damage flag Fd has the value one in step S140, the road surface damage determiner 23 determines that the road surface damage has occurred in the target section when the present routine was executed previous time, and compares the section maximum variation rate ΔVms with a threshold ΔVref2 (step S250). Here, the threshold ΔVref2 is a threshold used for determining whether or not the road surface damage that has occurred in the target section is eliminated. The threshold ΔVref2 is set in advance based on an experiment or analysis. When the road surface damage that has occurred in the target section is repaired and eliminated by a construction dealer, or the like, the section maximum variation rate ΔVms of this time decreases largely (to the level before the occurrence of the road surface damage). The process of step S250 is performed in consideration of this decrease.

In step S250, when the section maximum variation rate ΔVms is larger than the threshold ΔVref2, the road surface damage determiner 23 determines that the road surface damage that has occurred in the target section is not eliminated (continues), keeps the damage flag Fd to the value one, updates the history value ΔVh1 by the aforementioned process of step S240, and ends the present routine.

When the section maximum variation rate ΔVms is equal to or smaller than the threshold ΔVref2 in step S250, the road surface damage determiner 23 determines that the road surface damage is eliminated, changes the damage flag Fd from the value one to the value zero (step S260), and ends the present routine. When the road surface damage that has occurred in the target section is eliminated in this way, it is possible to detect the elimination.

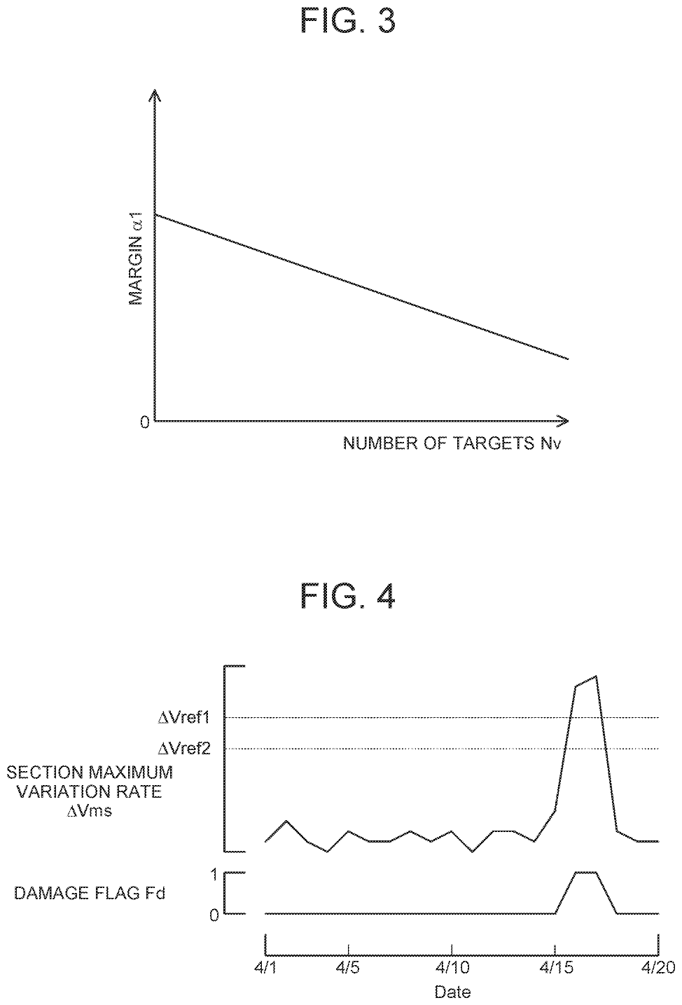

When the history flag Fh1 is set to the value one in step S150, the road surface damage determiner 23 determines that there is a history of the present routine detecting the road surface damage in the target section. Accordingly, the road surface damage determiner 23 sets a margin α1 using the number of targets Nv (the number of vehicle maximum variation rates ΔVmv[i] used for setting the section maximum variation rate ΔVms when the present routine is executed this time), and a margin setting map of FIG. 3 (step S170). Then, the road surface damage determiner 23 sets a value, obtained by subtracting the margin α1 from the history value ΔVh1 that is updated last time, as the threshold ΔVref1 (step S180), and executes the process subsequent to step S190.

The margin setting map of FIG. 3 is defined as the relationship between the number of targets Nv and the margin α1. The margin setting map is stored in the ROM (illustration omitted) of the arithmetic processing unit 21 or the storage device 28. As shown in the drawing, the margin α1 is set to be smaller as the number of targets Nv is larger. Therefore, as the number of targets Nv is larger, the threshold ΔVref1 approaches the history value ΔVh1. Since statistical certainty of the section maximum variation rate ΔVms becomes higher as the number of targets Nv is larger, it may be considered that the threshold ΔVref1 can be made closer to the history value ΔVh1.

Thus, the value obtained by subtracting the margin α1 from the history value ΔVh1 that is updated last time is set as the threshold ΔVref1. As a result, the threshold ΔVref1 can be set by effectively using the history of detecting the road surface damage in the target section (the section maximum variation rate ΔVms at the time). Accordingly, the threshold ΔVref1 can be set appropriately as compared with the case where a fixed value is used as the threshold ΔVref1. Since the margin α1 is set to be smaller as the number of targets Nv is larger, it is possible to set the margin α1 and, by extension, the threshold ΔVref1 more appropriately than the case of using a fixed value as the margin α1. As a result, when a road surface damage occurs for each of the road sections, the road surface damage can appropriately be detected.

FIG. 4 is an explanatory view showing examples of the section maximum variation rate ΔVms and the damage flag Fd of each date. In the example of FIG. 4, when the section maximum variation rate ΔVms largely increases and becomes equal to or greater than the threshold ΔVref1 on April 16, the server 20 determines the road surface damage has occurred, and changes the damage flag Fd from the value zero to the value one. In the embodiment, since the threshold ΔVref1 is set based on the history value ΔVh1 and the number of targets Nv, the road surface damage can be detected appropriately as compared with the case of using a fixed value as the threshold ΔVref1. The server 20 transmits a list, or the like, of the road sections where the road surface damage has occurred to the terminal device 40. As a consequence, the road surface damage is repaired by a construction dealer, or the like, who is commissioned by the user who operated the terminal device 40. Then, when the section maximum variation rate Vms decreases largely and becomes equal to or less than the threshold ΔVref2 on April 18, the server 20 determines the road surface damage is eliminated, and changes the damage flag Fd from the value one to the value zero.

The server 20, as the road surface damage detection device of the embodiment described in the foregoing, sets the value obtained by subtracting the margin α1 from the history value ΔVh1 that is updated last time as the threshold ΔVref1 for each of the road sections within a management target range. When the section maximum variation rate ΔVms is equal to or greater than the threshold ΔVref1, the server 20 determines that the road surface damage has occurred. Accordingly, as compared with the case of using a fixed value as threshold ΔVref1, the threshold ΔVref1 can be set appropriately, and when a road surface damage occurs for each of the road sections, the road surface damage can be detected appropriately. In addition, the margin α1 is set to be smaller as the number of targets Nv is larger. Hence, the margin α1, and by extension, the threshold ΔVref1 can be set appropriately as compared with the case of using a fixed value as the margin α1.

In the server 20 of the embodiment, when it is determined that the road surface damage has occurred (including the case where the road surface damage continues) for a target section, the smaller one of the section maximum variation rate ΔVms at that time and the previous history value (previous ΔVh1) is used to update the history value ΔVh1. However, when it is determined that the road surface damage has occurred, the section maximum variation rate ΔVms at that time may be used to update the history value ΔVh1.

In the server 20 of the embodiment, when it is determined that the road surface damage has occurred (including the case where the road surface damage continues) for the target section, the history value ΔVh1 is updated. However, when it is determined that the road surface damage continues, update of the history value ΔVh1 (the process of step S240 in the road surface damage determination routine of FIG. 2) may not be performed.

In consideration that the statistical certainty of the section maximum variation rate ΔVms becomes higher as the number of targets Nv is larger in the target section, the server 20 of the embodiment sets the margin α1 to be smaller as the number of targets Nv is larger. However, in place of or in addition to this, the margin α1 may be set smaller as the statistical certainty of the history value ΔVh1 becomes higher.

Here, the statistical certainty of the history value ΔVh1 becomes directly higher, as the number of times (the number of dates) of damage determination, that is the number of times that the present routine determines that the road surface damage has occurred (including the case where the road surface damage continues) in the target section in the past, i.e., the number of update times of the history value ΔVh1, is larger. Indirectly, the statistical certainty is assumed as follows. The statistical certainty is assumed to be higher as an integrated number of vehicles, that is an integrated number of targets Nv at each date when the present routine is executed after the operation of the server 20 is started for the target section or at each date when the present routine determines that the road surface damage has occurred in the target section, is larger. The statistical certainty is also assumed to be higher as an elapsed period after the operation of the server 20 is started for the target section is longer. Therefore, the margin α1 may be set based on at least one of the number of times of damage determination, the integrated number of vehicles, and the elapsed period.

The server 20 of the embodiment sets the margin α1 based on the number of targets Nv. However, a fixed value may be used as the margin α1.

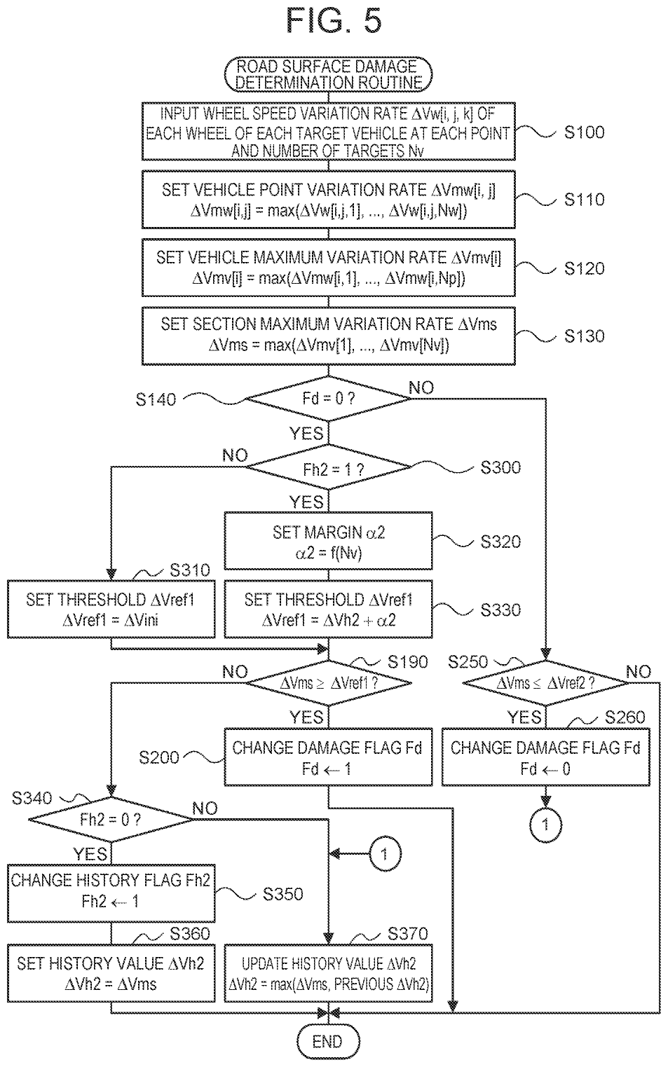

In the server 20 of the embodiment, the road surface damage determiner 23 executes the road surface damage determination routine of FIG. 2. However, the road surface damage determiner 23 may execute a road surface damage determination routine of FIG. 5 instead. The road surface damage determination routine of FIG. 5 is the same as that of the road surface damage determination routine of FIG. 2 except for the point that the process of steps S150 to S180 is replaced with the process of steps S300 to S330, the point that the process of steps S210 to S240 is removed, and the point that the process of steps S340 to S370 is added. Therefore, the processes in the road surface damage determination routine of FIG. 5, which are the same as those in the road surface damage determination routine of FIG. 2, are designated by the same step numbers, and a detailed description thereof is omitted. Hereinafter, the process of steps S340 to S370 will be described, and then the process of steps S300 to S330 will be described.

In the road surface damage determination routine of FIG. 5, when the section maximum variation rate ΔVms is less than the threshold ΔVref1 in step S190, the road surface damage determiner 23 determines that the road surface damage has not occurred in the target section, keeps the value of the damage flag Fd to zero, and checks the value of a history flag Fh2 (step S340). Here, the history flag Fh2 is a flag indicating whether or not there is a history of the present routine determining that the road surface damage has not occurred in the target section (the damage flag Fd being kept at the value zero). As the history flag Fh2, a value zero is set as an initial value when operation of the server 20 is started for the target section.

When the history flag Fh2 has the value zero in step S340, the road surface damage determiner 23 determines that there is no history of the present routine determining that the road surface damage has not occurred in the target section (determination is made for the first time), and changes the history flag Fh2 to the value one (step S350). Then, the road surface damage determiner 23 sets the section maximum variation rate ΔVms to the history value ΔVh2 (step S360), and ends the present routine. When the history value ΔVh2 is set in this way, the road surface damage determiner 23 stores, in the storage device 28, the road section set as the target section and the history value ΔVh2 in association with each other.

When the history flag Fh2 has the value one in step S340, the road surface damage determiner 23 determines that there is a history of the present routine determining that the road surface damage has not occurred in the target section, and keeps the history flag Fh2 to the value one. Then, as expressed by an expression (5), the road surface damage determiner 23 uses the larger one of the section maximum variation rate ΔVms and the history value ΔVh of previous time to update the history value ΔVh2 (step S370), and ends the present routine.

ΔVh2=max(ΔVms, previous ΔVh2) (5)

In step S250, when the section maximum variation rate ΔVms is equal to or smaller than the threshold ΔVref2, the road surface damage determiner 23 determines that the road surface damage that has occurred in the target section is eliminated, changes the damage flag Fd to the value zero from the value one (step S260), updates the history value ΔVh2 by the process of step S370, and ends the present routine.

When the history flag Fh2 has the value zero in step S300, the road surface damage determiner 23 determines that there is no history of the present routine determining that the road surface damage has not occurred in the target section, sets the initial value ΔVini as the threshold ΔVref1 (step S310) as in the process of step S160, and executes the process subsequent to step S190.

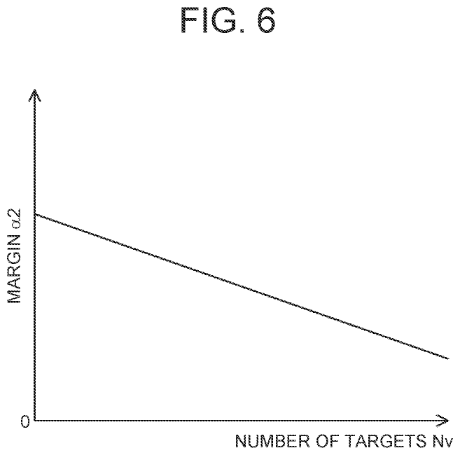

When the history flag Fh2 has the value one in step S300, the road surface damage determiner 23 determines that there is a history of the present routine determining that the road surface damage has not occurred in the target section, and sets a margin α2 using the number of targets Nv and a margin setting map of FIG. 6 (step S310). Then, the road surface damage determiner 23 sets a value, obtained by adding the margin α2 to the history value ΔVh 2 that is updated last time, as the threshold ΔVref1 (step S320), and executes the process subsequent to step S190.

The margin setting map of FIG. 6 is defined as the relationship between the number of targets Nv and the margin α2. The margin setting map is stored in the ROM (illustration omitted) of the arithmetic processing unit 21 or the storage device 28. As shown in the drawing, the margin α2 is set to be smaller as the number of targets Nv is larger. Therefore, as the number of targets Nv is larger, the threshold ΔVref1 approaches the history value ΔVh2. Since statistical certainty of the section maximum variation rate ΔVms becomes higher as the number of targets Nv is larger, it may be considered that the threshold ΔVref1 can be made closer to the history value ΔVh2.

Thus, the value obtained by adding the margin α2 to the history value ΔVh2 that is updated last time for the target section is set as the threshold ΔVref1. As a result, the threshold ΔVref1 can be set by effectively using the history of determining that the road surface damage has not occurred in the target section (the section maximum variation rate ΔVms at the time). Accordingly, the threshold ΔVref1 can be set appropriately as compared with the case where a fixed value is used as the threshold ΔVref1. Since the margin α2 is set to be smaller as the number of targets Nv is larger, it is possible to set the margin α2 and, by extension, the threshold ΔVref1 more appropriately than in the case of using a fixed value as the margin β2. As a result, when a road surface damage occurs for each of the road sections, the road surface damage can appropriately be detected.

In the road surface damage determination routine of the FIG. 5, when the road surface damage determiner 23 determines that the road surface damage has not occurred in the target section (including the case where the road surface damage has occurred and been eliminated), the road surface damage determiner 23 uses the larger one of the section maximum variation rate ΔVms at that time and the history value of previous time (previous ΔVh2) to update the history value ΔVh2. However, when determining that the road surface damage has not occurred, the road surface damage determiner 23 may use the section maximum variation rate ΔVms at that time to update the history value ΔVh2.

In the road surface damage determination routine of the FIG. 5, in consideration that the statistical certainty of the section maximum variation rate ΔVms becomes higher as the number of targets Nv is larger in the target section, the margin α2 is set to be smaller as the number of targets Nv is larger. However, in place of or in addition to this configuration, the margin α2 may be set smaller as the statistical certainty of the history value ΔVh2 becomes higher.

Here, the statistical certainty of the history value ΔVh2 directly becomes higher, as the number of times (the number of dates) of normal determination, that is the number of times that the present routine determines that the road surface damage has not occurred (including the case where the road surface damage has occurred and been eliminated) in the target section, i.e., the number of update times of the history value ΔVh2, is larger. Indirectly, the statistical certainty is assumed as follows. The statistical certainty is assumed to be higher, as an integrated number of vehicles that is an integrated number of targets Nv at each date when the present routine is executed after the operation of the server 20 is started for the target section, at each date when the present routine is executed after the road surface damage is repaired in the target section, or at each date when the present routine determines that the road surface damage has not occurred in the target section, is larger. The statistical certainty is also assumed to be higher as an elapsed period after the operation of the server 20 is started for the target section or after the road surface damage is repaired in the target section is longer. Therefore, the margin α2 may be set based on at least one of the number of times of normal determination, the integrated number of vehicles, and the elapsed period.

In the road surface damage determination routine of the FIG. 5, the margin α2 is set based on the number of targets Nv or the like. However, a fixed value may be used as the margin α2.

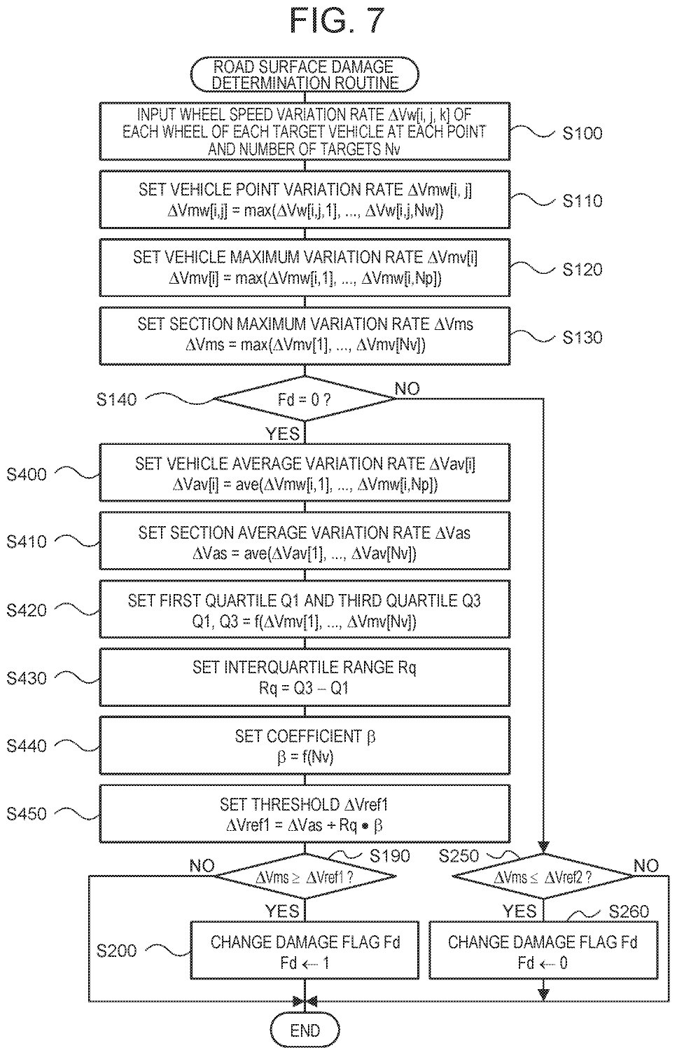

In the server 20 of the embodiment, the road surface damage determiner 23 executes the road surface damage determination routine of FIG. 2. However, the road surface damage determiner 23 may execute a road surface damage determination routine of FIG. 7 instead. The road surface damage determination routine of FIG. 7 is the same as that of the road surface damage determination routine of FIG. 2 except for the point that the process of steps S150 to S180 is replaced with the process of steps S400 to S450 and the point that the process of steps S210 to S240 is removed. Therefore, the processes in the road surface damage determination routine of FIG. 7, which are the same as those in the road surface damage determination routine of FIG. 2, are designated by the same step numbers, and a detailed description thereof is omitted.

In the road surface damage determination routine of FIG. 7, when the damage flag Fd has a value zero in step S140, the road surface damage determiner 23 determines that the road surface damage has not occurred in the target section when the present routine was executed previous time. Then, the road surface damage determiner 23 calculates an average of the vehicle point variation rates ΔVmw[i, 1] to ΔVmw[i, Np] at each point set in step S110 for each target vehicle, and sets the average as a vehicle average variation rate ΔVav[i] in the target section (step S400). The process is performed as expressed by expression (6), in which a sum total of the vehicle point variation rates ΔVmw[i, 1] to ΔVmw[i, Np] is divided by the number of points Np within the target section for each of the target vehicles, and a resultant value is set as the vehicle average variation rate ΔVav[i].

ΔVav[i]=(ΔVmw[i, 1]+ . . . +ΔVmw1[i, Np])/Np (6)

Then, the road surface damage determiner 23 calculates an average of the vehicle average variation rates ΔVav[1] to ΔVav[Nv] in the target section for each of the target vehicles, and sets the average as a section average variation rate ΔVas in the target section for all the target vehicles (step S410). The process is performed as expressed by expression (7), in which a sum total of the vehicle average variation rates ΔVav[1] to ΔVav[Nv] is divided by the number of targets Nv, and a resultant value is set as the section average variation rate ΔVas.

ΔVas=(ΔVav[1]+ . . . +ΔVav[Nv])/Nv (7)

Then, based on the vehicle maximum variation rates ΔVmv[1] to ΔVmv[Nv] in the target section for each of the target vehicles set in step S120, the road surface damage determiner 23 sets a first quartile Q1, a third quartile Q3, and an interquartile range Rq (steps S420, S430).

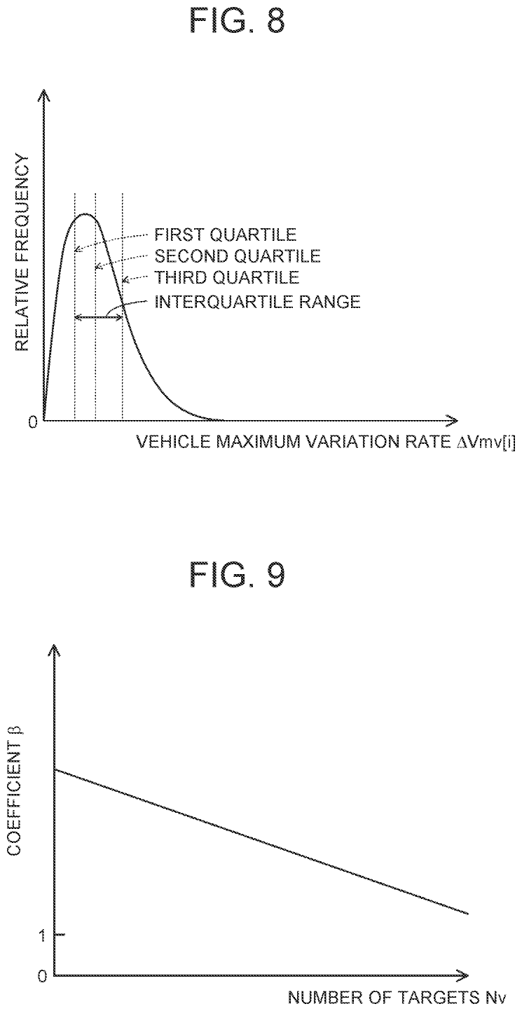

FIG. 8 is an explanatory view showing an example of the relationship between the vehicle maximum variation rate ΔVmv[i] and relative frequency. In the drawing, the first quartile Q1, the second quartile Q2, and the third quartile Q3 are values at positions corresponding to 25%, 50%, and 75% from a lower side of the vehicle maximum variation rate ΔVmv[i]. Therefore, the second quartile Q2 corresponds to a median. The interquartile range Rq is a value obtained by subtracting the first quartile Q1 from the third quartile Q3.

The process of steps S420 and S430 is performed by setting the first quartile Q1 and the third quartile Q3 using the vehicle maximum variation rates ΔVmv[1] to ΔVmv[Nv], subtracting the first quartile Q1 from the third quartile Q3, and setting a resultant value as the interquartile range Rq.

Next, the road surface damage determiner 23 sets a coefficient β using the number of targets Nv and a coefficient setting map of FIG. 9 (step S440). Then, as expressed by an expression (8), the road surface damage determiner 23 sets as the threshold ΔVref1 a sum of the section average variation rate ΔVas and a value obtained by multiplying the interquartile range Rq by the coefficient β (step S450), and executes the process subsequent to step S190.

ΔVref1=ΔVas+Rq·β (8)

The coefficient setting map of FIG. 9 is defined as the relationship between the number of targets Nv and the coefficient β. The coefficient setting map is stored in the ROM (illustration omitted) of the arithmetic processing unit 21 or the storage device 28. As shown in the drawing, the coefficient β is set to be smaller as the number of targets Nv is larger within the range of a value one or larger. Therefore, as the number of targets Nv is larger, the threshold ΔVref1 approaches the sum of the section average variation rate ΔVas and the interquartile range Rq. As the number of targets Nv is larger, the statistical certainty of the section maximum variation rate ΔVms used for comparison with the threshold ΔVref1, and the statistical certainty of the section average variation rate ΔVas and the interquartile range Rq used for setting the threshold ΔVref1 become higher. Accordingly, it may be considered that the threshold ΔVref1 can be made closer to the sum of the section average variation rate ΔVas and the interquartile range Rq.

Thus, when the sum of the section average variation rate ΔVas and the value obtained by multiplying the interquartile range Rq by the coefficient β is set as the threshold ΔVref1 for the target section, the threshold ΔVref1 can be set in consideration of the section average variation rate ΔVas and the interquartile range Rq. Accordingly, the threshold ΔVref1 can be set appropriately as compared with the case where a fixed value is used as the threshold ΔVref1. Since the coefficient β is set to be smaller as the number of targets Nv is larger, it is possible to set the coefficient β and, by extension, the threshold ΔVref1 more appropriately than in the case of using a fixed value as the coefficient β. As a result, when a road surface damage occurs for each of the road sections, the road surface damage can appropriately be detected.

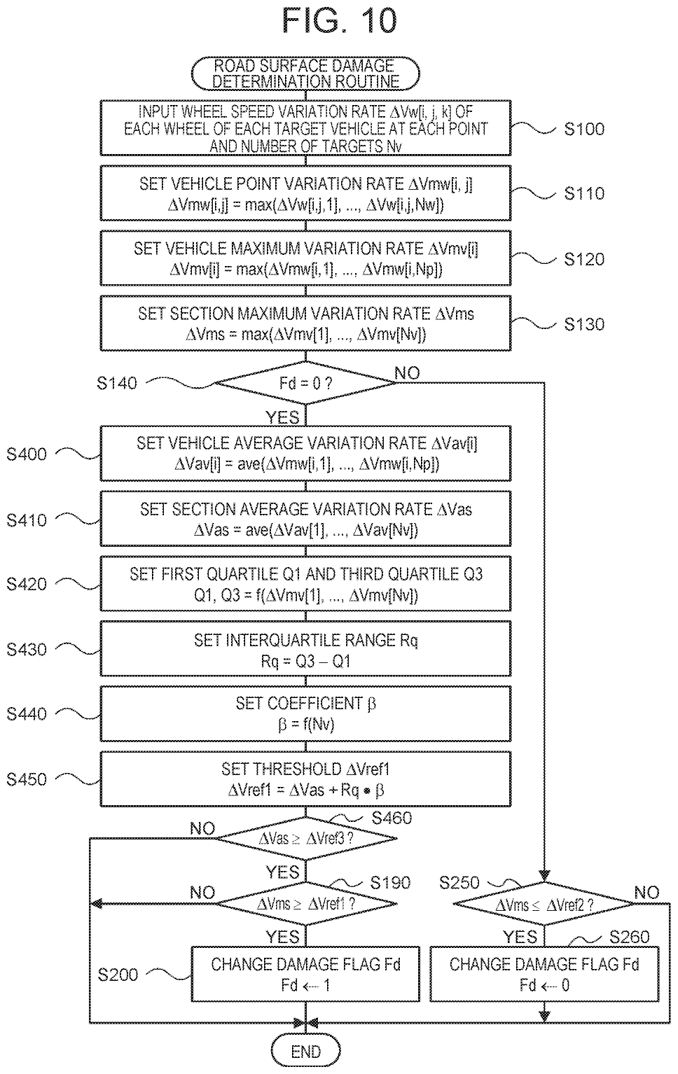

In the modification, the road surface damage determiner 23 executes the road surface damage determination routine of FIG. 7. However, the road surface damage determiner 23 may execute a road surface damage determination routine of FIG. 10 instead. The road surface damage determination routine of FIG. 10 is the same as the road surface damage determination routine of FIG. 7 except for the point that the process of step S460 is added. Therefore, the processes in the road surface damage determination routine of FIG. 10, which are the same as those in the road surface damage determination routine of FIG. 7, are designated by the same step numbers, and a detailed description thereof is omitted.

In the road surface damage determination routine of FIG. 10, the road surface damage determiner 23 compares the section average variation rate ΔVas with a threshold ΔVref3 after the process of step S450 (step S460). Here, the threshold ΔVref3 is a threshold used for determining whether or not a possibility of the road surface damage having occurred in the target section needs to be considered. The threshold ΔVref3 is set in advance based on analysis or an experiment. When a long period is not elapsed after a road is constructed or repaired in the target section, it may be considered that the condition of the road surface is good, and a possibility that the road surface damage, such as a pothole, occurs is sufficiently low. Therefore, it may be considered that the section average variation rate ΔVas is relatively small. The process of step S460 is performed in consideration of this assumption.

When the section average variation rate ΔVas is equal to or greater than the threshold ΔVref3 in step S460, the road surface damage determiner 23 determines that the possibility of the road surface damage having occurred in the target section needs to be considered. Accordingly, the road surface damage determiner 23 executes the process of steps S190, S200, and ends the present routine. On the contrary, when the section average variation rate ΔVas is less than the threshold ΔVref3, the road surface damage determiner 23 determines that it is not necessary to consider the possibility that the road surface damage has occurred in the target section (the possibility that the road surface damage has occurred is sufficiently low). Accordingly, the road surface damage determiner 23 ends the present routine without executing the process of steps S190, S200.

In the road surface damage determination routine of FIG. 7 or FIG. 10, the coefficient β is set based on the number of targets Nv. However, a fixed value may be used as the coefficient β.

In the road surface damage determination routine of FIGS. 7 and 10, the sum of the section average variation rate ΔVas and the value obtained by multiplying the interquartile range Rq by the coefficient β is set as the threshold ΔVref1. However, a value obtained by multiplying the section average variation rate ΔVas by a coefficient β2 may be set as the threshold ΔVref1. In this case, as the number of targets Nv is larger, the coefficient β2 may be set to be smaller within the range larger than the value one, or a fixed value may be used as the coefficient β2.

In the road surface damage determination routine of FIGS. 7 and 10, for each of the target sections, the section average variation rate ΔVas, the interquartile range Rq, and the coefficient β are set based on the vehicle average variation rate ΔVav[i], the vehicle maximum variation rate ΔVmv[i], and the number of targets Nv of this time, respectively. However, the section average variation rate ΔVas, the interquartile range Rq, and the coefficient β may be set based on the vehicle average variation rate ΔVav[i], the vehicle maximum variation rate ΔVmv[i], and an integrated number of targets Nv at each date when the present routine is executed after the operation of the server 20 is started for the target section, at each date when the present routine is executed after the road surface damage is repaired in the target section, or at each date when the present routine determines that the road surface damage has not occurred (including the case where the road surface damage has occurred and been eliminated) in the target section, respectively.

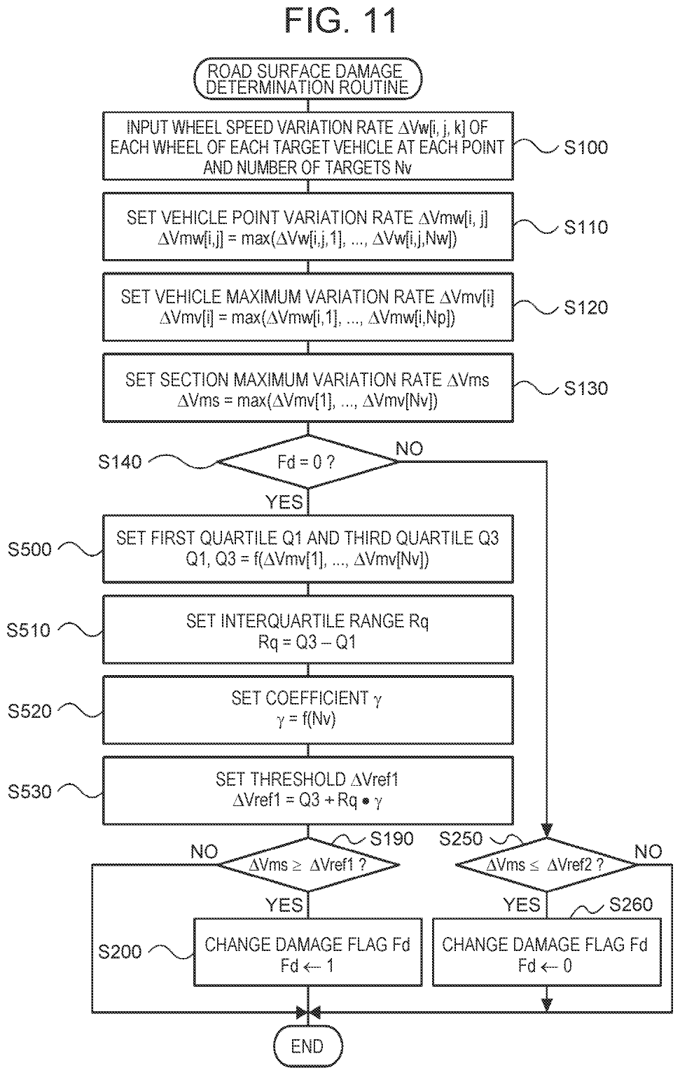

In the server 20 of the embodiment, the road surface damage determiner 23 executes the road surface damage determination routine of FIG. 2. However, the road surface damage determiner 23 may execute a road surface damage determination routine of FIG. 11 instead. The road surface damage determination routine of FIG. 11 is the same as the road surface damage determination routine of FIG. 2 except for the point that the process of steps S150 to S180 is replaced with the process of steps S500 to S530, and the point that the process of steps S210 to S240 is removed. Therefore, the processes in the road surface damage determination routine of FIG. 11, which are the same as those in the road surface damage determination routine of FIG. 2, are designated by the same step numbers, and a detailed description thereof is omitted.

In the road surface damage determination routine of FIG. 11, when the damage flag Fd has a value zero in step S140, the road surface damage determiner 23 determines that the road surface damage has not occurred in the target section when the present routine was executed previous time. Then, as in the case of the process of steps S420, S430 in the road surface damage determination routine of FIG. 7, the road surface damage determiner 23 sets the first quartile Q1, the third quartile Q3, and the interquartile range Rq based on the vehicle maximum variation rates ΔVmv[1] to ΔVmv[Nv] in the target section for each of the target vehicles (steps S500, S510).

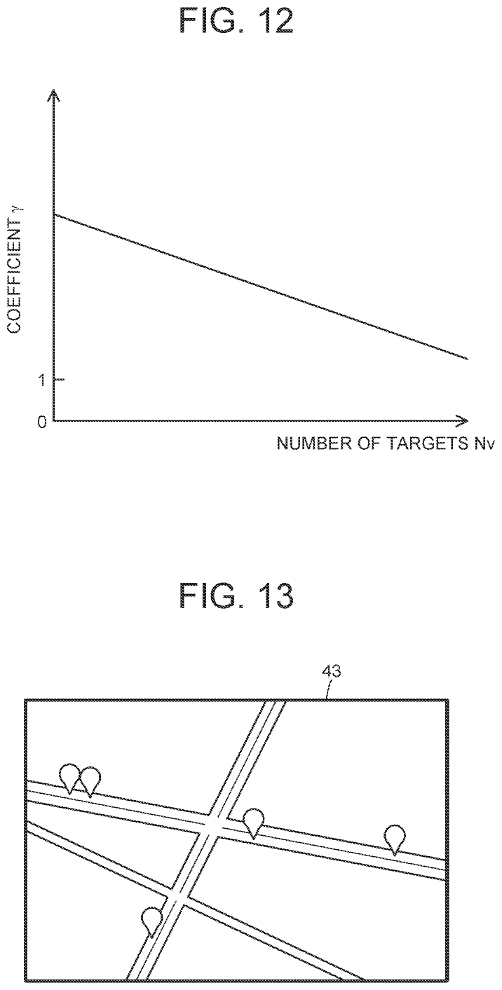

Next, the road surface damage determiner 23 sets a coefficient γ using the number of targets Nv and a coefficient setting map of FIG. 12 (step S520). Then, as expressed by an expression (9), the road surface damage determiner 23 sets as the threshold ΔVref1 a sum of the third quartile Q3 and a value obtained by multiplying the interquartile range Rq by the coefficient γ (step S530), and executes the process subsequent to step S190.

ΔVref1=Q3+Rq·γ (9)

Thus, when the sum of the third quartile Q3 and the value obtained by multiplying the interquartile range Rq by the coefficient γ is set as the threshold ΔVref1 for the target section, the threshold ΔVref1 can be set in consideration of the third quartile Q3 and the interquartile range Rq. Accordingly, the threshold ΔVref1 can be set appropriately as compared with the case where a fixed value is used as the threshold ΔVref1. Since the coefficient γ is set to be smaller as the number of targets Nv is larger, it is possible to set the coefficient γ and, by extension, the threshold ΔVref1 more appropriately than in the case of using a fixed value as the coefficient γ. As a result, when a road surface damage occurs for each of the road sections, the road surface damage can appropriately be detected.

In the road surface damage determination routine of FIG. 11, the coefficient γ is set based on the number of targets Nv. However, a fixed value may be used as the coefficient γ.

In the road surface damage determination routine of FIG. 11, the sum of the third quartile Q3 and the value obtained by multiplying the interquartile range Rq by the coefficient γ is set as the threshold ΔVref1. However, any one of a sum of the second quartile Q2 and a value obtained by multiplying the interquartile range Rq by a coefficient γ2, a value obtained by multiplying the second quartile Q2 by a coefficient γ3, and a value obtained by multiplying the third quartile Q3 by a coefficient γ4, may also be set as the threshold ΔVref1. In these cases, as the number of targets Nv is larger, the coefficients γ2, γ3, γ4 may be set to be smaller within the range larger than the value one, or a fixed value may be used as the coefficients.

In the road surface damage determination routine of FIG. 11, the third quartile Q3, the interquartile range Rq, and the coefficient γ are set for the target section based on the vehicle maximum variation rate ΔVmv[i] and the number of targets Nv of this time. However, the third quartile Q3 and the interquartile range Rq, and the coefficient γ may be set based on the vehicle maximum variation rate ΔVmv[i] and an integrated number of targets Nv, at each date when the present routine is executed after the operation of the server 20 is started for the target section, at each date when the present routine is executed after the road surface damage is repaired in the target section, or at each date when the present routine determines that the road surface damage has not occurred (including the case where the road surface damage has occurred and been eliminated) in the target section, respectively. This may also apply to the case of setting the second quartile Q2 in place of the third quartile Q3, or the case of setting any of the coefficients γ2, γ3, and γ4 in place of the coefficient γ.

In the server 20 of the embodiment and the modifications, the road surface damage determiner 23 executes the road surface damage determination routine of any one of FIGS. 2, 5, 7, 10, and 11. However, when the number of targets Nv is equal to or greater than the threshold Nvref, the threshold ΔVref1 may be set based on the road surface damage determination routine of any one of FIGS. 2 and 5. When the number of targets Nv is less than the threshold Nvref, the threshold ΔVref1 may be set based on the road surface damage determination routine of any one of FIGS. 7, 10 and 11. Here, the threshold Nvref is a threshold used for determining whether or not the statistical certainty of the section maximum variation rate ΔVms, used for comparison with the threshold ΔVref1, is reliable to some extent. The threshold Nvref is defined in advance based on an experiment or analysis. When the statistical certainty of the section maximum variation rate ΔVms used for comparison with the threshold ΔVref1 is relatively low, it is preferable to set the margin α1 or the margin α2 to be relatively large in the case of setting the threshold ΔVref1 according to the road surface damage determination routine of any one of FIGS. 2 and 5 (see FIGS. 3 and 5). Accordingly, it may also be considered to set the threshold ΔVref1 by using the section average variation rate ΔVas, the third quartile Q3, and the interquartile range Rq.

In the server 20 of the embodiment, when the damage flag Fd has the value one (the road surface damage has been detected) and the section maximum variation rate ΔVms is equal to or smaller than the threshold ΔVref2 for each road section, the road surface damage determiner 23 determines that the road surface damage is eliminated, and changes the damage flag Fd to the value zero. However, in place of or in addition to this configuration, when the damage flag Fd has the value one, and a signal indicating that the repair of the road surface damage is completed is received from a construction dealer or the like who repaired the road surface damage, the road surface damage determiner 23 may determine that the road surface damage is eliminated, and may change the damage flag Fd to the value zero.

In the server 20 of the embodiment, the information provider 24 prepares a list, or the like, of the road sections where the road surface damage has occurred, and transmits the list or the like to the terminal device 40. However, the information provider 24 may execute a following display image process in accordance with the operation of the input device 42 by a user (for example, a person in charge of a government office, etc.).

In the display image process, the information provider 24 applies a state image (for example, image of pins) relating to the road surface damage to roads in a display map displayed on the display 43 of the terminal device 40, and transmits the data to the computer 41 of the terminal device 40. Accordingly, the display map and the state image are displayed on the display 43. Here, the display map is defined by a display contraction scale and a display range (for example, all or some of the management target range) desired by the user. FIG. 13 is an explanatory view showing an example of a display screen of a display 43. In the drawing, pins indicate road sections where the road surface damage has occurred. With this configuration, the user who checked the display 43 can easily recognize the road sections where the road surface damage has occurred.

In the embodiment, the present disclosure is applied to the aspect of the server 20 as the road surface damage detection device, and to the aspect of the road surface damage detection method. However, the present disclosure may be applied to the aspect as a program for causing the server 20 to function as the road surface damage detection device.

Correspondence relation between the main elements of the embodiment and the main elements of the present disclosure described in Summary will be described. In the embodiment, the road surface damage determiner 23 corresponds to the “first processor” and the “second processor”.

Since the correspondence relation between the main elements of the embodiment and the main elements of the present disclosure described in Summary is one example for specific description of the aspect for carrying out the present disclosure described in Summary, the correspondence relation is not intended to limit the elements of the disclosure described in Summary. More specifically, the disclosure disclosed in Summary should be interpreted based on the description therein, and the embodiments are merely specific examples of the disclosure disclosed in Summary.

Although the aspects for carrying out the present disclosure have been described using the embodiments, the present disclosure is not limited in any manner to the embodiments disclosed. It should naturally be understood that the present disclosure can be carried out in various aspects without departing from the scope of the present disclosure.

The present disclosure is applicable in the fields such as manufacturing of the road surface damage detection device.

What is claimed is:

1. A road surface damage detection device for detecting a road surface damage for each of road sections based on vehicle information from each of vehicles that have traveled, the road surface damage detection device comprising:
a first processor configured to calculate, for each of the road sections, a maximum variation rate that is a maximum value of a variation amount of a wheel speed per unit time in each of the vehicles; and
a second processor configured to select, for each of the road sections, a maximum value from the maximum variation rate of each of the vehicles in a first prescribed period, set the selected maximum value as a section maximum variation rate, and determine whether or not the road surface damage has occurred by comparing the section maximum variation rate with a threshold, wherein
the second processor sets the threshold, for each of the road sections, based on a behavior of each of the vehicles in a second prescribed period or based on the behavior of each of the vehicles when a predetermined condition is satisfied.

2. The road surface damage detection device according to claim 1, wherein the second processor sets as the threshold a value that is smaller by a margin than the section maximum variation rate when determining that the road surface damage has occurred in past, for each of the road sections.

3. The road surface damage detection device according to claim 2, wherein
the second processor sets the margin for each of the road sections, based on any one of the number of vehicles when determining that the road surface damage has occurred in the second prescribed period or in the past, the number of times of determination that the road surface damage has occurred in the past, and elapsed time from a prescribed time.

4. The road surface damage detection device according to claim 1, wherein the second processor sets as the threshold a value that is larger by a margin than the section maximum variation rate when determining that the road surface damage has not occurred in past, for each of the road sections.

5. The road surface damage detection device according to claim 4, wherein the second processor sets the margin for each of the road sections, based on any one of the number of vehicles when determining that the road surface damage has not occurred in the second prescribed period or in the past, the number of times of determination that the road surface damage has not occurred in the past, and elapsed time from a prescribed time.

6. The road surface damage detection device according to claim 2, wherein:
the first processor calculates, for each of the road sections, an average variation rate that is an average of the variation amount of the wheel speed per unit time in each of the vehicles; and
when the number of vehicles for each of the road sections in the first prescribed period is less than a predetermined number, the second processor sets as a section average variation rate an average of the average variation rate of each of the vehicles when determining that the road surface damage has not occurred in the second prescribed period or in the past, and sets the threshold based on the section average variation rate.

7. The road surface damage detection device according to claim 2, wherein when the number of vehicles for each of the road sections in the first prescribed period is less than a predetermined number, the second processor calculates a second quartile or a third quartile using the maximum variation rate of each of the vehicles when determining that the road surface damage has not occurred in the second prescribed period or in the past, and sets the threshold based on the second quartile or the third quartile.

8. The road surface damage detection device according to claim 1, wherein:
the first processor calculates, for each of the road sections, an average variation rate that is an average of the variation amount of the wheel speed per unit time in each of the vehicles; and
the second processor sets as a section average variation rate an average of the average variation rate of each of the vehicles when determining that the road surface damage has not occurred in the second prescribed period or in the past, and sets the threshold based on the section average variation rate, for each of the road sections.

9. The road surface damage detection device according to claim 6, wherein the second processor calculates an interquartile range using the maximum variation rate of each of the vehicles when determining that the road surface damage has not occurred in the second prescribed period or in the past, and sets as the threshold a sum of the section average variation rate and a value obtained by multiplying the interquartile range by a coefficient.

10. The road surface damage detection device according to claim 1, wherein the second processor calculates, for each of the road sections, a second quartile and a third quartile using the maximum variation rate of each of the vehicles when determining that the road surface damage has not occurred in the second prescribed period or in the past, and sets the threshold based on the second quartile or the third quartile.

11. The road surface damage detection device according to claim 7, wherein the second processor calculates, for each of the road sections, an interquartile range using the maximum variation rate of each of the vehicles when determining that the road surface damage has not occurred in the second prescribed period or in the past, and sets as the threshold a sum of the second quartile or the third quartile and a value obtained by multiplying the interquartile range by a coefficient.

12. The road surface damage detection device according to claim 9, wherein the second processor sets the coefficient based on the number of vehicles when determining that the road surface damage has not occurred in the second prescribed period or in the past.

13. A road surface damage detection method for detecting a road surface damage for each of road sections based on vehicle information from each of vehicles that have traveled, the method comprising:
(a) a step of calculating, for each of the road sections, a maximum variation rate that is a maximum value of a variation amount of a wheel speed per unit time in each of the vehicles; and
(b) a step of selecting, for each of the road sections, a maximum value from the maximum variation rate of each of the vehicles in a first prescribed period, setting the selected maximum value as a section maximum variation rate, and determining whether or not the road surface damage has occurred by comparing the section maximum variation rate with a threshold, wherein
in the step (b), the threshold is set, for each of the road sections, based on a behavior of each of the vehicles in a second prescribed period or based on the behavior of each of the vehicles when a predetermined condition is satisfied.

14. A program for causing a computer to function as a road surface damage detection device for detecting a road surface damage for each of road sections based on vehicle information from each of vehicles that have traveled, the program comprising:
(a) a step of calculating, for each of the road sections, a maximum variation rate that is a maximum value of a variation amount of a wheel speed per unit time in each of the vehicles; and
(b) a step of selecting, for each of the road sections, a maximum value from the maximum variation rate of each of the vehicles in a first prescribed period, setting the selected maximum value as a section maximum variation rate, and determining whether or not the road surface damage has occurred by comparing the section maximum variation rate with a threshold, wherein
in the step (b), the threshold is set, for each of the road sections, based on a behavior of each of the vehicles in a second prescribed period or based on the behavior of each of the vehicles when a predetermined condition is satisfied.
